(19) United States
(12) Patent Application Publication
(10) Pub. No.: US 2016/0245518 A1
(43) Pub. Date: Aug. 25, 2016

(54) COMBUSTOR PANEL WITH MULTIPLE ATTACHMENTS

(71) Applicant: UNITED TECHNOLOGIES CORPORATION, Hartford, CT (US)

(72) Inventor: Christopher Drake, West Hartford, CT (US)

(21) Appl. No.: 15/024,589

(22) PCT Filed: Aug. 1, 2014
(86) PCT No.: PCT/US2014/049398

§ 371 Date: Mar. 24, 2016

Related U.S. Application Data
(60) Provisional application No. 61/886,987, filed on Oct. 4, 2013.

(51) Int. Cl. F23R 3/00; F02C 7/24

(52) U.S. Cl. CPC F23R 3/007; F02C 7/24

(57) ABSTRACT

A liner panel for a combustor of a gas turbine engine is provided that includes a first attachment and a second attachment that extends from a cold side of the liner panel. The first attachment is different than the second attachment. A combustor of a gas turbine engine is provided that includes an inner combustor wall assembly with an inner support shell and a multiple of inner liner panels. At least one of the multiple of inner liner panels includes a first inner attachment to the inner support shell and a second inner attachment to the inner support shell. The first inner attachment is different than, and upstream of, the second inner attachment. An outer combustor wall assembly is spaced from the inner combustor wall assembly to define an annular combustion cavity therebetween.

### CROSS-REFERENCE TO RELATED APPLICATION

This application claims priority to U.S. Patent Application No. 61/886,987 filed Oct. 4, 2013, which is hereby incorporated herein by reference in its entirety.

### STATEMENT REGARDING FEDERALLY SPONSORED RESEARCH OR DEVELOPMENT

This disclosure was made with Government support under FA8650-09-D-2923 0021 awarded by the United States Air Force. The Government may have certain rights in this disclosure.

### BACKGROUND

The present disclosure relates to a gas turbine engine and, more particularly, to a combustor section therefor.

Gas turbine engines, such as those that power modem commercial and military aircraft, generally include a compressor section to pressurize an airflow, a combustor section to burn a hydrocarbon fuel in the presence of the pressurized air, and a turbine section to extract energy from the resultant combustion gases.

The combustor section typically includes an inner and outer double wall assembly each with an outer shell lined with heat shields to define an annular combustion chamber. The floatwall liner panels are attached to the outer shell with studs and nuts. These attachments have been sufficient and achievable due to the spatial availability of legacy engine diffuser cases. In certain engine architectures, however, these attachments may pose packing issues with regard to the engine case structure.

### SUMMARY

A liner panel for a gas turbine engine, according to one disclosed non-limiting embodiment of the present disclosure, includes a first attachment and a second attachment that extends from a cold side of the liner panel. The first attachment is different than the second attachment.

In a further embodiment of the present disclosure, the first attachment includes a stud and a clip engageable with the stud.

In a further embodiment of any of the foregoing embodiments of the present disclosure, the first attachment is upstream of the second attachment.

In a further embodiment of any of the foregoing embodiments of the present disclosure, the second attachment includes a threaded stud and a nut.

In a further embodiment of any of the foregoing embodiments of the present disclosure, the first attachment includes a stud and a clip engageable with the clip.

In a further embodiment of any of the foregoing embodiments of the present disclosure, the second attachment includes a trapped interface.

In a further embodiment of any of the foregoing embodiments of the present disclosure, the first attachment includes a trapped interface.

In a further embodiment of any of the foregoing embodiments of the present disclosure, the second attachment includes a stud and a clip engageable with the stud.

In a further embodiment of any of the foregoing embodiments of the present disclosure, the first attachment is upstream of the second attachment.

In a further embodiment of any of the foregoing embodiments of the present disclosure, the liner panel is manufactured of a ceramic.

A combustor of a gas turbine engine, according to another disclosed non-limiting embodiment of the present disclosure, includes an inner combustor wall assembly with an inner support shell and a multiple of inner liner panels. At least one of the multiple of inner liner panels includes a first inner attachment to the inner support shell and a second inner attachment to the inner support shell. The first inner attachment different than, and upstream of, the second inner attachment. An outer combustor wall assembly is spaced from the inner combustor wall assembly to define an annular combustion cavity therebetween.

In a further embodiment of any of the foregoing embodiments of the present disclosure, the first inner attachment includes a stud and a clip engageable with the stud.

In a further embodiment of any of the foregoing embodiments of the present disclosure, the second inner attachment includes a threaded stud and a nut.

In a further embodiment of any of the foregoing embodiments of the present disclosure, the second inner attachment includes a trapped interface.

In a further embodiment of any of the foregoing embodiments of the present disclosure, a bulkhead assembly is mounted to the inner combustor wall assembly and the outer combustor wall assembly.

In a further embodiment of any of the foregoing embodiments of the present disclosure, the first inner attachment includes a trapped interface with a bulkhead panel of the bulkhead assembly.

In a further embodiment of any of the foregoing embodiments of the present disclosure, the multiple of inner liner panels are manufactured of a ceramic.

In a further embodiment of any of the foregoing embodiments of the present disclosure, the bulkhead panel is manufactured of a metallic alloy.

In a further embodiment of any of the foregoing embodiments of the present disclosure, the outer combustor wall assembly includes an outer support shell and a multiple of outer liner panels. At least one of the multiple of outer liner panels includes a first outer attachment to the outer support shell and a second outer attachment to the outer support shell. The first outer attachment equivalent to the second outer attachment.

In a further embodiment of any of the foregoing embodiments of the present disclosure, the first outer attachment and the second outer attachment each includes a threaded stud and a nut.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of an example gas turbine engine architecture;

FIG. 2 is a schematic cross-section of another example gas turbine engine architecture;

FIG. 3 is an expanded longitudinal schematic sectional view of a combustor section according to one non-limiting embodiment that may be used with the example gas turbine engine architectures shown in FIGS. 1 and 2;

FIG. 4 is an expanded longitudinal schematic sectional view of a combustor section with an inner wall assembly having different first and second attachments according to one disclosed non-limiting embodiment;

FIG. 5 is a perspective view of an annular combustor with annular inner and outer wall assemblies;

FIG. 6 is a sectional view of the annular combustor of FIG. 5 along an engine axis;

FIG. 7 is an expanded exploded view of one liner panel attachment according to one disclosed non-limiting embodiment;

FIG. 8 is an expanded exploded view of one liner panel attachment according to one disclosed non-limiting embodiment;

FIG. 9 is an expanded longitudinal schematic sectional view of a combustor section with an inner wall assembly having different first and second attachments according to another disclosed non-limiting embodiment;

FIG. 10 is a perspective view of one liner panel attachment according to one disclosed non-limiting embodiment;

FIG. 11 is a perspective view of one liner panel attachment according to one disclosed non-limiting embodiment;

FIG. 12 is a longitudinal sectional view of one liner panel attachment according to one disclosed non-limiting embodiment;

FIG. 13 is a longitudinal sectional view of one liner panel attachment according to one disclosed non-limiting embodiment; and

FIG. 14 is an expanded longitudinal schematic sectional view of a combustor section with an inner wall assembly having different first and second attachments according to another disclosed non-limiting embodiment.

### DETAILED DESCRIPTION

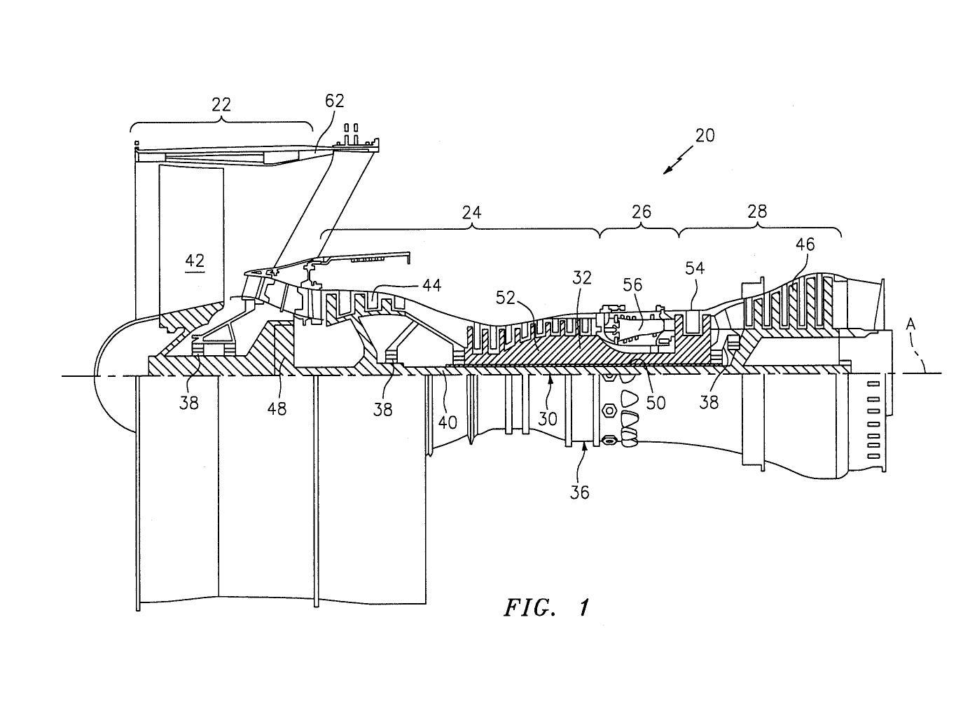

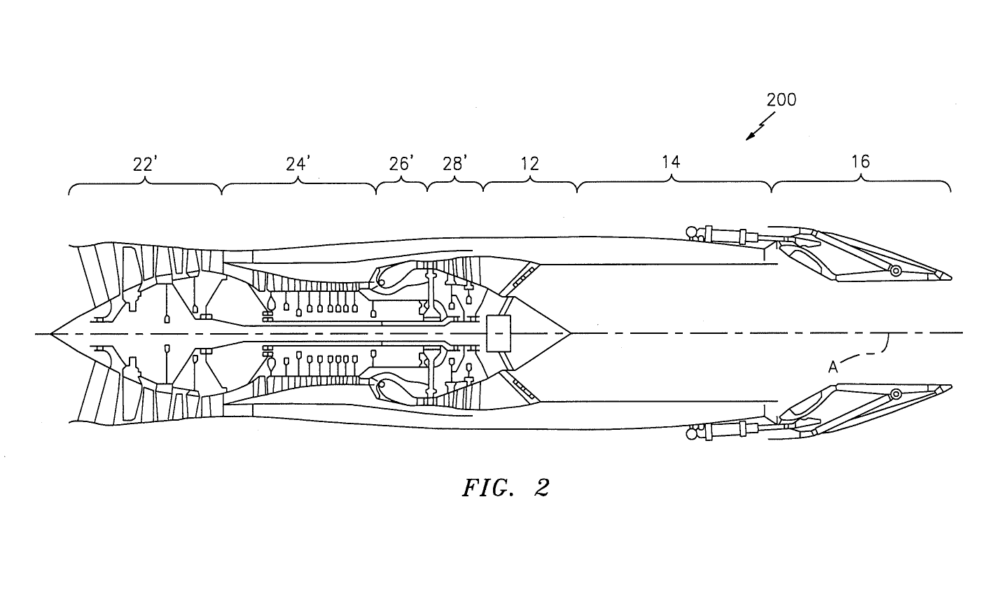

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. Referring to FIG. 2, another alternative engine architecture 200 might include an augmentor section 12, an exhaust duct section 14 and a nozzle section 16 in addition to the fan section 22′, compressor section 24′, combustor section 26′ and turbine section 28′. Referring again to FIG. 1, although depicted as an aero engine in the disclosed non-limiting embodiment, it should be understood that the concepts described herein are not so limited and the teachings may be applied to other types of turbine engines such as a turbojets, turboshafts, and three-spool (plus fan) turbofans with an intermediate spool as well as industrial gas turbines.

The fan section 22 drives air along a bypass flowpath and into the compressor section 24. The compressor section 24 drives air along a core flowpath for compression and communication into the combustor section 26, which then expands and directs the air through the turbine section 28. The engine 20 generally includes a low spool 30 and a high spool 32 mounted for rotation about an engine central longitudinal axis A relative to an engine static structure 36 via several bearing structures 38. The low spool 30 generally includes an inner shaft an inner shaft 40 that interconnects a fan 42, a low pressure compressor (“LPC”) 44 and a low pressure turbine (“LPT”) 46. The inner shaft 40 may drive the fan 42 directly or through a geared architecture 48 as illustrated in FIG. 1 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor (“HPC”) 52 and a high pressure turbine (“HPT”) 54. A combustor 56 is arranged between the HPC 52 and the HPT 54. The inner shaft 40 and the outer shaft 50 are concentric and rotate about the engine central longitudinal axis A which is collinear with their longitudinal axes.

Core airflow is compressed by the LPC 44 then the HPC 52, mixed with the fuel and burned in the combustor 56, then expanded over the HPT 54 and the LPT 46. The LPT 46 and HPT 54 rotationally drive the respective low spool 30 and high spool 32 in response to the expansion.

In one non-limiting example, the gas turbine engine 20 is a high-bypass geared aircraft engine with a bypass ratio greater than about six (6:1). The geared architecture 48 can include an epicyclic gear train, such as a planetary gear system or other gear system. The example epicyclic gear train has a gear reduction ratio of greater than about 2.3:1, and in another example, is greater than about 2.5:1. The geared turbofan enables operation of the low spool 30 at higher speeds which can increase the operational efficiency of the LPC 44 and LPT 46 to render increased pressure in a fewer number of stages.

A pressure ratio associated with the LPT 46 is pressure measured prior to the inlet of the LPT 46 as related to the pressure at the outlet of the LPT 46 prior to an exhaust nozzle of the gas turbine engine 20. In another non-limiting example, the bypass ratio of the gas turbine engine 20 is greater than about ten (10:1), the fan diameter is significantly larger than that of the LPC 44, and the LPT 46 has a pressure ratio greater than about five (5:1). It should be appreciated, however, that the above parameters are only exemplary of a geared architecture engine and that the present disclosure is applicable to other gas turbine engines including direct drive turbofans.

In an example high-bypass turbofan, significant thrust is provided by the high bypass ratio as the fan section 22 may be designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC) which is an industry standard parameter of fuel consumption per unit of thrust.

Fan Pressure Ratio is the pressure ratio across a fan blade of the fan section 22 without the use of a Fan Exit Guide Vane system. The low Fan Pressure Ratio according to one example gas turbine engine 20 is less than 1.45. Low Corrected Fan Tip Speed is the actual fan tip speed divided by an industry standard temperature correction of (“Tram”/518.7)^{0.5}. The Low Corrected Fan Tip Speed according to the example gas turbine engine 20 is less than about 1150 fps (351 m/s).

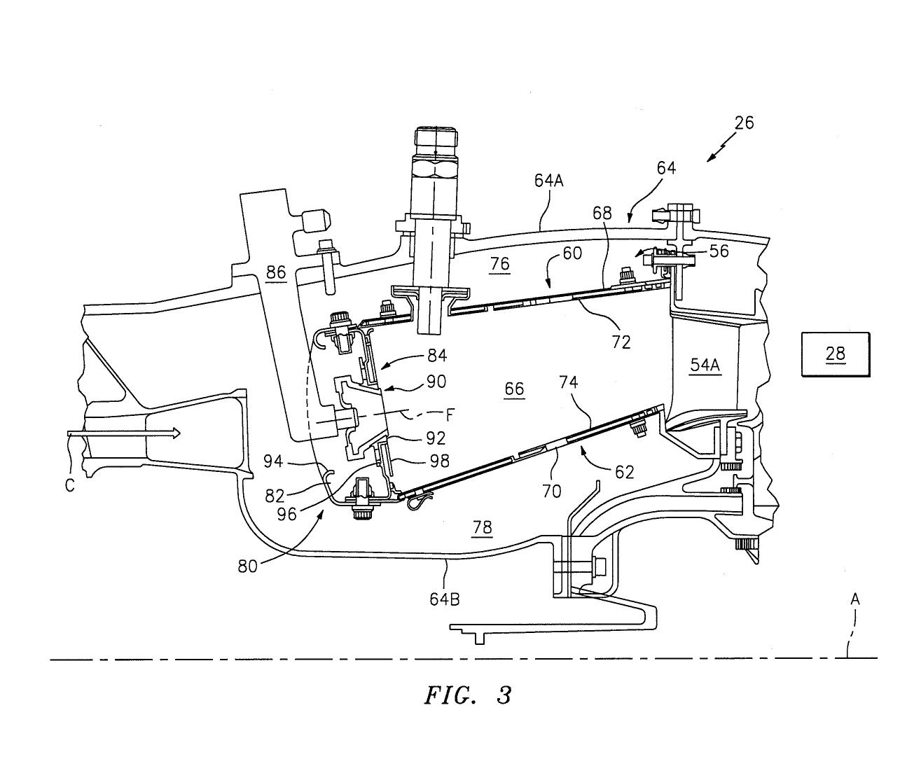

With reference to FIG. 3, the combustor section 26 generally includes a combustor 56 with an outer combustor wall assembly 60, an inner combustor wall assembly 62 and a diffuser case module 64. The outer combustor wall assembly 60 and the inner combustor wall assembly 62 are spaced apart such that an annular combustion chamber 66 is defined therebetween.

The outer combustor wall assembly 60 is spaced radially inward from an outer diffuser case 64A of the diffuser case module 64 to define an outer annular plenum 76. The inner combustor wall assembly 62 is spaced radially outward from an inner diffuser case 64B of the diffuser case module 64 to define an inner annular plenum 78. It should be understood that although a particular combustor is illustrated, other combustor types with various combustor wall and diffuser case module arrangements will also benefit herefrom.

The combustor wall assemblies 60, 62 contain the combustion products for direction toward the turbine section 28. Each combustor wall assembly 60, 62 generally includes a respective outer and inner support shell 68, 70 which supports one or more liner panels 72, 74 mounted within the respective support shell 68, 70. Each of the liner panels 72, 74 may be generally rectilinear with a circumferential arc and manufactured of, for example, a nickel based super alloy, ceramic or other temperature resistant material and are arranged to form a liner array of circumferentially and/or radially staggered liner panels 72, 74.

The combustor 56 further includes a forward assembly 80 immediately downstream of the compressor section 24 to receive compressed airflow therefrom. The forward assembly 80 generally includes an annular hood 82 and a bulkhead assembly 84 that support a multiple of fuel nozzles 86 (one shown) and a multiple of swirlers 90 (one shown) along an axis F. The annular hood 82 extends radially between, and is secured to, the forwardmost ends of the combustor wall assemblies 60, 62. The annular hood 82 includes a multiple of circumferentially distributed hood ports 94 that accommodate the respective fuel nozzle 86 and introduce air into the forward end of the combustion chamber 66 through a respective swirler 90. The bulkhead assembly 84 includes a bulkhead support shell 96 secured to the combustor wall assemblies 60, 62, and a multiple of circumferentially distributed bulkhead liner panels 98 secured to the bulkhead support shell 96. Each fuel nozzle 86 may be secured to the diffuser case module 64 and project through one of the hood ports 94 and respective swirlers 90.

The forward assembly 80 introduces core combustion air into the forward section of the combustion chamber 66 while the remainder enters the outer annular plenum 76 and the inner annular plenum 78. The multiple of fuel nozzles 86 and adjacent structure generate a fuel-air mixture that supports stable combustion in the combustion chamber 66.

Opposite the forward assembly 80, the outer and inner support shells 68, 70 are mounted adjacent to a first row of Nozzle Guide Vanes (NGVs) 54A in the HPT 54. The NGVs 54A are static engine components which direct core airflow combustion gases onto turbine blades in the turbine section 28 to facilitate the conversion of pressure energy into kinetic energy. The core airflow combustion gases are also accelerated by the NGVs 54A because of their convergent shape and are typically given a “spin” or a “swirl” in the direction of turbine rotor rotation.

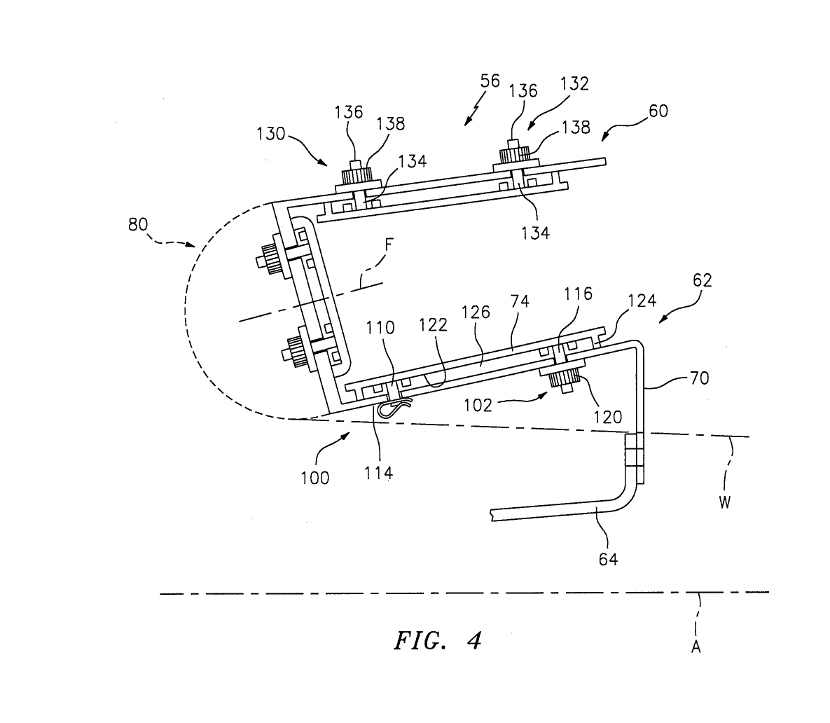

With reference to FIG. 4, the inner liner panels 74 (only one shown) include a first attachment 100 and a second attachment 102, where the first attachment 100 is upstream of the second attachment 102. That is, the first attachment 100 is closer to the forward assembly 80 than the second attachment 102. The first attachment 100 and the second attachment 102 attach each of the respective inner liner panel 74 to the inner support shell 70.

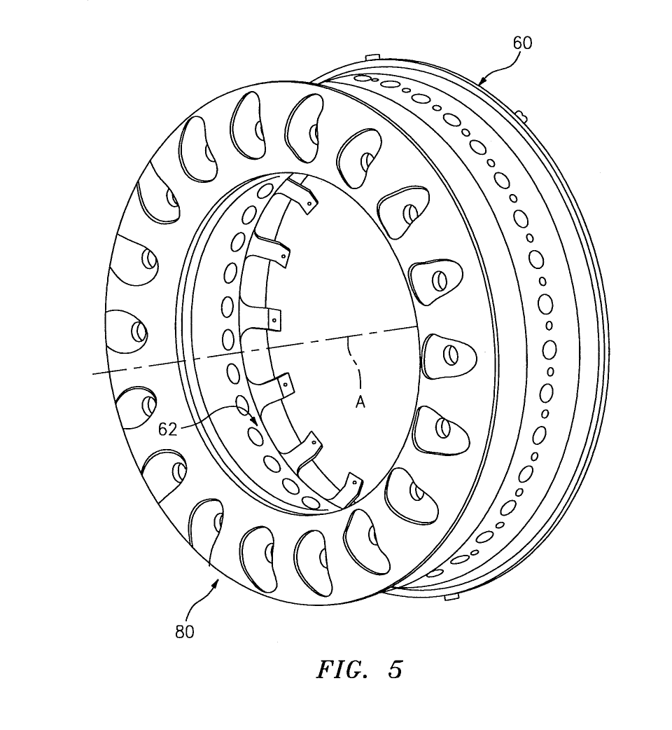

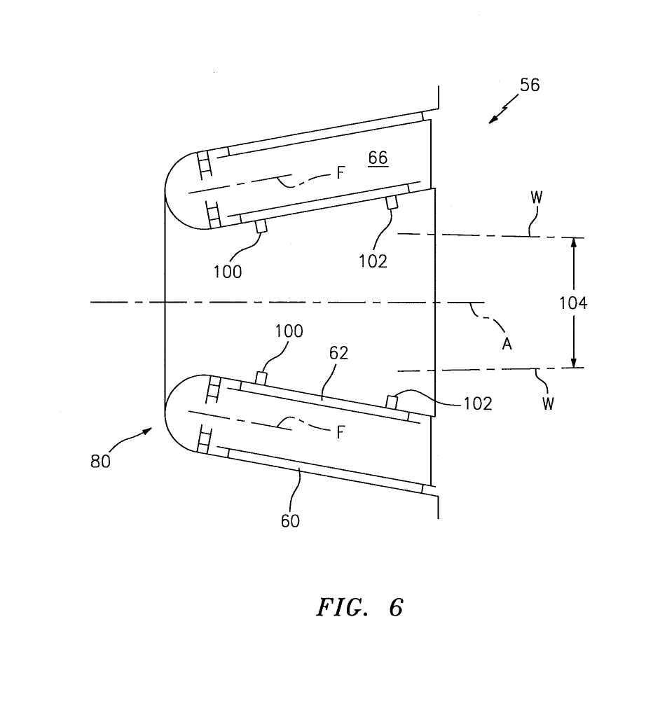

The combustor wall assemblies 60, 62 of the annular combustor 56 (FIG. 5) are canted outward from the forward assembly 80 with respect to the interface NGVs 54A such that the first attachment 100 and the second attachment 102 are sized to permit passage of the annular combustor 56 through the diffuser case module 64 for assembly and maintenance. That is, the diffuser case module 64 defines an opening 104 with an inner boundary W (illustrated schematically by a phantom line) through which the annular combustor 56 with the first attachment 100 and the second attachment 102 are sized to pass (also shown in FIG. 6). That is, the upstream first attachment 100 is sized to be radially smaller than the second attachment 102 so that the first attachment 100 will not extend beyond inner boundary W to permit axial aft passage of the outward canted inner combustor wall assembly 62.

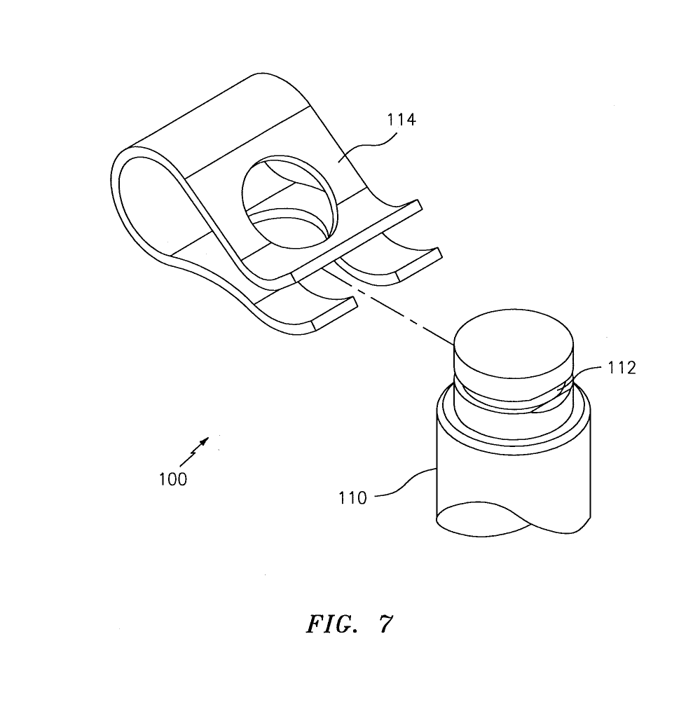

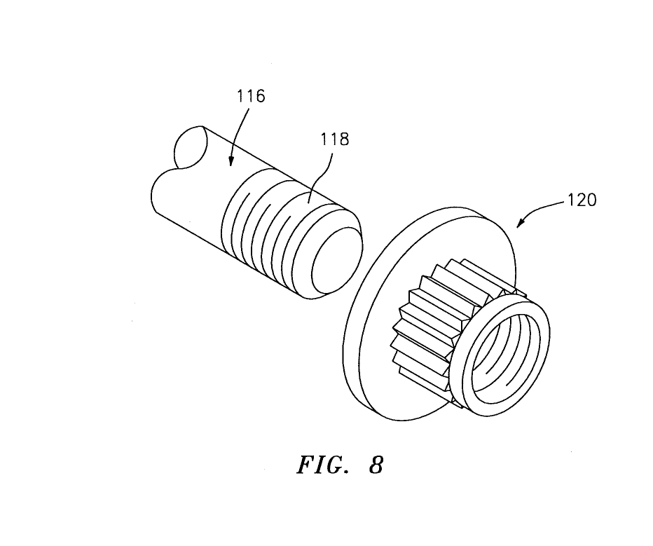

With continued reference to FIG. 4, according to one disclosed non-limiting embodiment, the first attachment 100 includes a multiple of studs 110 each with an aperture 112 to receive respective clip 114 (FIG. 7) such as an “R-clip” or other such retainer. The second attachment 102 includes a multiple of studs 116 each with a threaded section 118 to receive respective fastener 120 such as a nut (FIG. 8). The studs 110, 116 project rigidly from a cold side 122 of the liner panels 74 opposite a hot side which is directly exposed to combustion gases. The studs 110, 116 extend through the support shell 70 to receive the respective clips 114 and fasteners 120 to secure the liner panels 74 thereto.

A rail 124 typically extends at least partially around the periphery of the cold side 122 to interface with the support shell 70 when mounted thereto and to define one or more impingement cavities 126. That is, the rails 120 at least extend around the cold side 122 periphery and may include further internal rails to define additional compartments.

The studs 110 of the first attachment 100 extends a shorter distance from the cold side 122 than the studs 116 of the second attachment 102 so that the first attachment 100 will not extend beyond inner boundary W and permit axial passage of the outward canted inner combustor wall assembly 62. That is, the first attachment 100 and the second attachment 102 permit passage through opening 104 (FIG. 6).

As the annular combustor 56 is canted outward, the outer wall assembly 60, in this disclosed non-limiting embodiment, may include a third attachment 130 that is equivalent to the downstream fourth attachment 132. The third attachment 130 and the fourth attachment 132 may, for example, include relatively conventional studs 134 each with a threaded section 136 to receive respective fasteners 138 such as a nut. It should be appreciated that various attachments may be utilized for the outer wall assembly 60 either similar or different than that of the inner wall assembly 62.

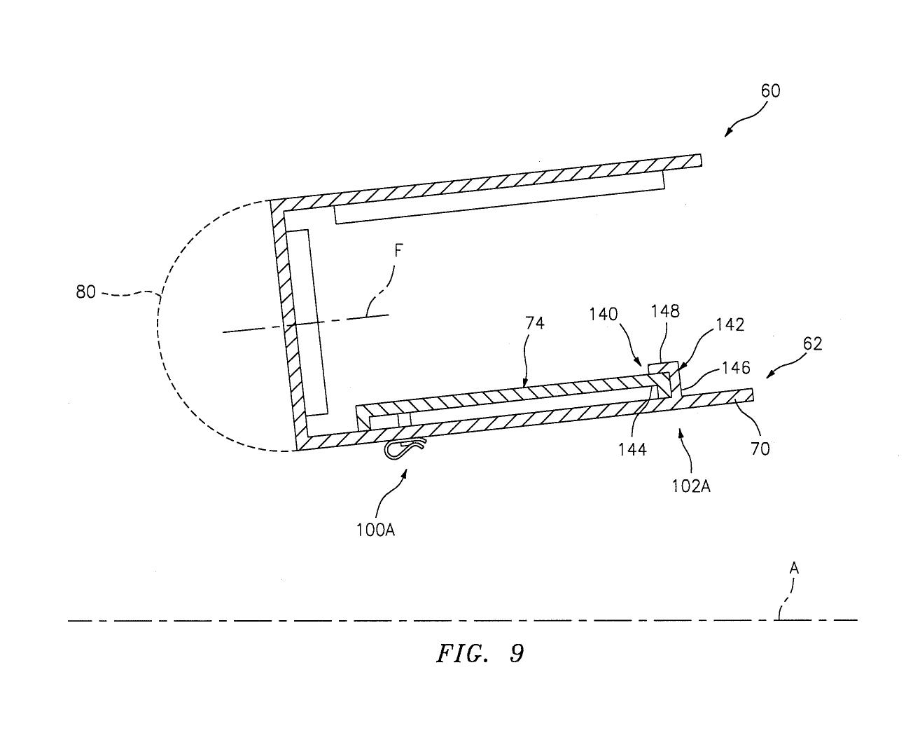

With reference to FIG. 9, according to another disclosed non-limiting embodiment, the second attachment 102A includes a trapped interface 140. The trapped interface 140 includes a projection 142 that extends from the support shell 70 into which an aft edge 144 of the liner panel 74 is received. That is, the trapped interface 140 retains the aft end 144 of the liner panel 74, which is secured by the first attachment 100A. In this disclosed non-limiting embodiment, the liner panel 74 is manufactured of a ceramic material and the support shell 70 is manufactured of a metal alloy. The support shell 70 permits thermal expansion yet retains the ceramic liner panel 74. The trapped interface 140 also facilitates elimination of hard bolting that may otherwise potentially lead to ceramic cracking during thermal expansion of the support shell 70.

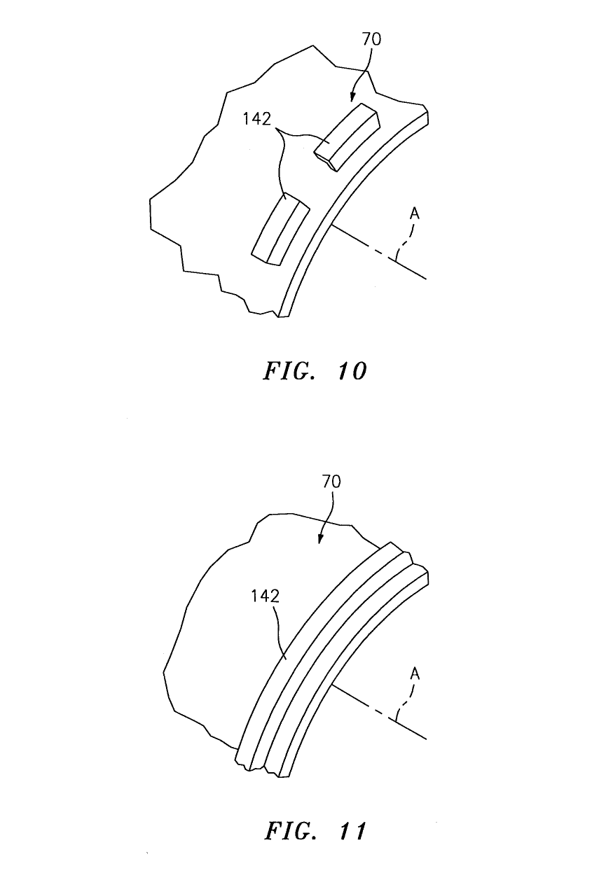

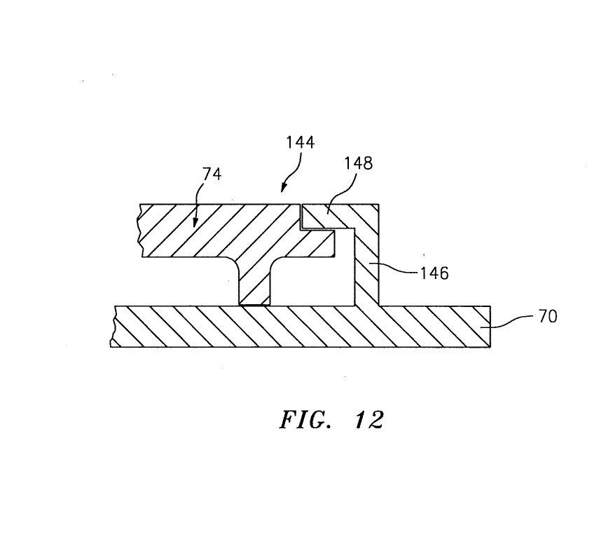

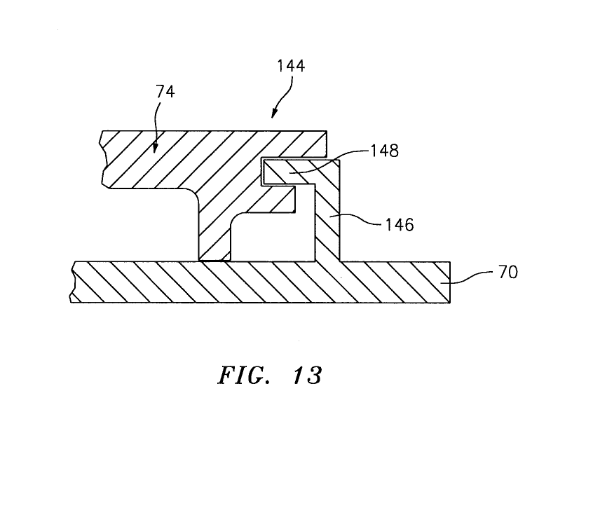

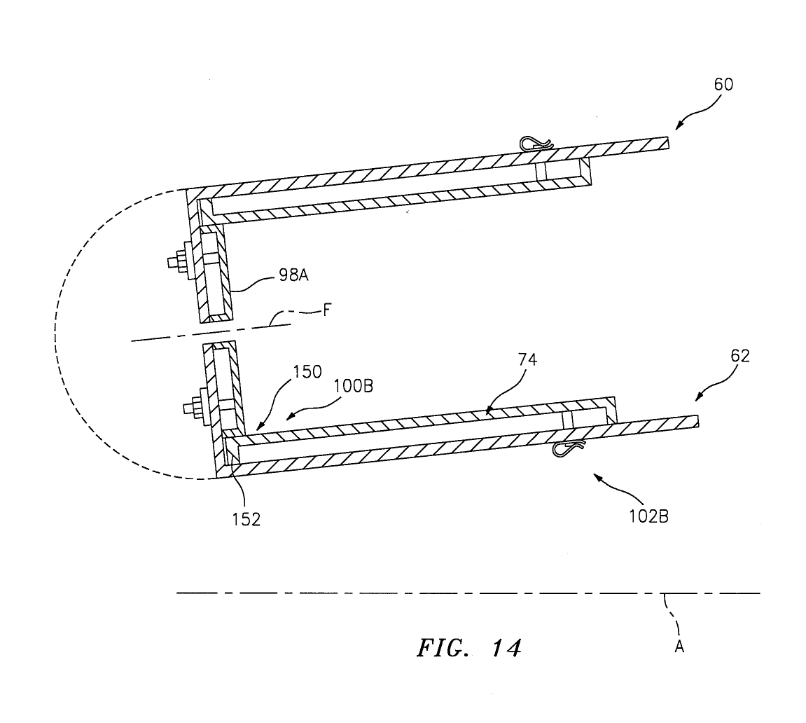

In this disclosed non-limiting embodiment, the projection 142 includes a radial portion 146 and an axial portion 148 the projection 142 may be segmented (FIG. 10) or continuous (FIG. 11) about the full circumference of the support shell 70. Further, the axial portion 144 may be coplanar (FIG. 12) or recessed (FIG. 13) with respect to a hot side of the liner panel 74 such that the axial portion 144 need no be directly exposed to combustion gases.

With reference to FIG. 14, according to another disclosed non-limiting embodiment, the first attachment 100B includes a trapped interface 150. The trapped interface 150 includes a forward end 152 of the liner panel 74 that is trapped by the transverse bulkhead liner panels 98A. That is, the trapped interface 150 retains the forward end 152 of the liner panel 74, which is then secured by the second attachment 102B. In this disclosed non-limiting embodiment, the liner panel 74 is manufactured of a ceramic material and the transverse bulkhead liner panels 98A are manufactured of a metal alloy. As the metal alloy has a higher coefficient to of thermal expansion, the bulkhead liner panels 98A expands more than the liner panel 74 which is retained by the bulkhead liner panels 98A.

The different attachments arrangements facilitate a relatively lighter weight combustor that can be located in a relatively smaller package space. In addition, threaded studs are minimized which may lead to panel hot spots around rails.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the features within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A liner panel for a gas turbine engine, comprising:
a first attachment; and
a second attachment that extends from a cold side of the liner panel;
wherein the first attachment is different than the second attachment.

2. The liner panel as recited in claim 1, wherein the first attachment includes a stud and a clip engageable with the stud.

3. The liner panel as recited in claim 2, wherein the first attachment is upstream of the second attachment.

4. The liner panel as recited in claim 3, wherein the second attachment includes a threaded stud and a nut.

5. The liner panel as recited in claim 5, wherein the first attachment includes a stud and a clip engageable with the clip.

6. The liner panel as recited in claim 3, wherein the second attachment includes a trapped interface.

7. The liner panel as recited in claim 1, wherein the first attachment includes a trapped interface.

8. The liner panel as recited in claim 7, wherein the second attachment includes a stud and a clip engageable with the stud.

9. The liner panel as recited in claim 8, wherein the first attachment is upstream of the second attachment.

10. The liner panel as recited in claim 1, wherein the liner panel is manufactured of a ceramic.

11. A combustor of a gas turbine engine, comprising:
an inner combustor wall assembly with an inner support shell and a multiple of inner liner panels, at least one of the multiple of inner liner panels including a first inner attachment to the inner support shell and a second inner attachment to the inner support shell, wherein the first inner attachment is different than, and upstream of, the second inner attachment; and
an outer combustor wall assembly spaced from the inner combustor wall assembly to define an annular combustion cavity therebetween.

12. The combustor as recited in claim 11, wherein the first inner attachment includes a stud and a clip engageable with the stud.

13. The combustor as recited in claim 12, wherein the second inner attachment includes a threaded stud and a nut.

14. The combustor as recited in claim 12, wherein the second inner attachment includes a trapped interface.

15. The combustor as recited in claim 11, further comprising a bulkhead assembly mounted to the inner combustor wall assembly and the outer combustor wall assembly.

16. The combustor as recited in claim 15, wherein the first inner attachment includes a trapped interface with a bulkhead panel of the bulkhead assembly.

17. The combustor as recited in claim 16, wherein the multiple of inner liner panels are manufactured of a ceramic.

18. The combustor as recited in claim 17, wherein the bulkhead panel is manufactured of a metallic alloy.

19. The combustor as recited in claim 11, wherein the outer combustor wall assembly includes an outer support shell and a multiple of outer liner panels, at least one of the multiple of outer liner panels includes a first outer attachment to the outer support shell and a second outer attachment to the outer support shell, and the first outer attachment is equivalent to the second outer attachment.

20. The combustor as recited in claim 11, wherein the first outer attachment and the second outer attachment each includes a threaded stud and a nut.
